(19) United States
(12) Patent Application Publication
(10) Pub. No.: US 2016/0372990 A1
(43) Pub. Date: Dec. 22, 2016

(54) Method to Convert Human Movement into Electrical Energy

(71) Applicant: Jonathan Perry Williamson, Alpharetta, GA (US)

(72) Inventor: Jonathan Perry Williamson, Alpharetta, GA (US)

(73) Assignee: Jonathan Perry Williamson, Alpharetta, GA (US)

(21) Appl. No.: 14/745,413

(22) Filed: Jun. 20, 2015

(51) Int. Cl. H02K 7/18; H02J 7/14; F03G 5/08

(52) U.S. Cl. CPC H02K 7/1853; F03G 5/08; H02J 7/14

(57) ABSTRACT

At the moment, electrical energy production had become a rising problem due to the depletion of fossil fuels, increasing world population, and growing energy consumption per capita. Despite growing research in traditional methods of exploiting electrical energy (steam, wind, water, and nuclear electrical plants) less attention has been given in using human movement as energy source. The present invention will attempt to convert human body movement into electrical energy using electric dynamos.

### PRIOR ART

U.S. Pat. No. 7,977,807 B1 Jul. 12, 2011 Connor
U.S. Pat. No. 8,581,426 B2 Nov. 12, 2013 SEIKE
U.S. Pat. No. 6,182,378 B1 Feb. 6, 2001 Sendaula

### EP 2449568 A1 May 9, 2012 Melito

### US 20130217289 A1 Aug. 22, 2013 Nayfeh, Nayfeh, Yau

### US 268205 A Nov. 28, 1882 Edison

U.S. Pat. No. 3,063,001 A Nov. 6, 1962 Richard L

### FIELD OF INVENTION

The present invention relates to converting human movement into electricity. More particularly, the present invention relates to the conversion of body movement (e.g. leg, arm, shoulder, wrist, finger) into electricity energy which can then be stored or directly used to power electrical devices.

### BACKGROUND OF THE INVENTION

At the moment, electrical energy production had become a rising problem due to the depletion of fossil fuels, increasing world population, and growing energy consumption per capita. In general, electricity is produced using an electric dynamo to convert kinetic energy to electrical energy. Typically electric dynamos are utilized in steam, wind, water, and nuclear electrical plants to produce electric energy from some sort if kinetic energy.

Despite growing research in traditional methods of exploiting electrical energy (steam, wind, water, and nuclear electrical plants) less attention has been given in using human movement as energy source. This human movement is not limited to, but can include arm and leg motion (walking), shoulder, wrist, and finger motion. In Dr. Bassett et. al's study “Pedometer-measured physical activity and health behaviors in U.S. adults”, United States citizens from different geographic locations were given pedometers and asked to calculate the number of steps they walked each day. The results showed that the average American walks approximately 5,700 steps a day (Bassett et. al). If this energy could be exploited it would increase energy production in an environmentally friendly way.

This present invention could also be used to provide a source of electricity to individuals in developing countries. Similarly in the future it could be used to charge portable electronic devices including, but not limiting to cell phones, MP3 players, watches, and portable media players.

### SUMMARY OF THE INVENTION

The present invention provides a method of converting human movement into electrical energy in a portable fashion. This differs from typical methods of converting human movement into electrical energy, such as the human movement converter into electricity that appears in typical exercise equipment (e.g. cycling machines), in the way that it is portable and can be worn by individuals as they perform daily activities, including but not limiting to, walking, running, or climbing stairs

The present invention consists of two bars which are attached by an electric dynamo. The electric dynamo serves as a “joint” and rotates as body motion occurs. In applications were the present invention is used to convert leg motion (e.g. walking, running, or climbing stairs) into electrical energy, the first bar is placed horizontally, slightly above the backside of the knee joint on the femur. The first bar is used to hold the electric dynamo in place (Note: the electric dynamo box containing the components that produce electricity is held in place, not the axle) while the second bar rotates. The second bar is attached to the electric dynamo's axle, so when the bar bends, the axle rotates. The second bar is placed vertically on the outer side of the fibula. This bar rotates moves back and forth as leg motion occurs (e.g. walking, running, or climbing stairs). The movement of the second bar causes the electric dynamo's axle to rotate and electricity to be produced (See FIG. 1 for a diagram of the present invention's placement on the leg). Note: the present invention is placed on the human skin and does not directly touch the bones mentioned. Additionally, the bones mentioned were used to aid in understand the present invention placement and the present invention may be placed over other areas of the body not mentioned.

The first bar of the present invention attaches horizontally, slightly above the backside of the knee joint on the femur via 2 Velcro™ straps that wrap around the femur in a crisscross fashion. The second bar of the present invention attaches vertically on the outer side of the fibula via 2 Velcro™ straps the horizontally wrap around the fibula and tibia. (See FIG. 4 for a diagram of the present invention's placement on the leg). Note: the present invention is placed on the human skin and does not directly touch the bones mentioned. Additionally, the bones mentioned were used to aid in understand the present invention placement and the present invention may be placed over other areas of the body not mentioned.

The electric dynamo is placed in such as fashion that it rotates in unison with the knee joint. Furthermore, as the knee joint bends when walking, the electric dynamo rotates in unison with the knee bending, and electricity is produced.

The electrical energy produced is stored in an electrical storage device including, but not limited to a supercapacitor or rechargeable AA battery.

These and other features, aspects and advantages of the present invention will become better understood with reference to the following description and appended claims. The accompanying drawings, which are incorporated in and constitute a part of this specification, illustrate an embodiment of the invention and, together with the description, serve to explain the principles of the invention.

### DETAILED DESCRIPTION OF THE REPRESENTATIVE EMBODIMENTS

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention cover such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention.

### DEFINITIONS

Electric dynamo: “pertaining to the conversion of mechanical energy into electric energy, or vice versa: a dynamoelectric Machine” (dictionary.com). The components of a DC motor are an electrical power source, coiled copper wire or an armature, and permanent magnets. A DC motor works when electricity flows through the coiled wire or armature and causes an electromagnetic field to be created. This electromagnetic field is repelled by the permanent magnetics causing mechanical energy to me created. A DC electric dynamo works in the opposite fashion, as the armature is revolved around an axis causing electromagnetic displacement between the permanent magnet and armature resulting in electricity being created.

Supercapacitor: A capacitor is basically an electrical component that is used to store small amounts of electrical current that can be used for various applications the circuitry of appliances. A capacitor is made up of two conductive plates and an insulating dielectric. Current is passed through one of the electric plates, however cannot pass through the second one due to the insulating dielectric. Electrons build up on one of the plates and their electrical field cause electrons to be repelled off the other plate. This causes one plate to have an excessive amount of electrons and the other to have an excessive amount of protons. This creates a difference between the amounts of electrons on each side of two terminals, thus creating voltage. Voltage is essentially just the potential difference between electrons between two points in a circuit (Battery University)(KEMET). Capacitors have one flaw, they cannot hold significant amounts of electricity like AA rechargeable batteries can. In fact the charge of the capacitor is so minuet that most commercial capacitors are measured in micro-Farads (the unit of capacitance). Recent technological developments have enable the creation of supercapacitors or capacitors that have a capacitance of over 1-Farad (KEMET). Previously 1 Farad capacitors had to be the size of a room in order to reach that size of capacitance, but now a 50-Farad capacitors can be the length of a quarter. This new advancement in the level of capacitance in capacitors is due to advances in the type of dielectric. The level of capacitance of capacitors is directly related to the permittivity (the amount of resistance in the process of forming an electric field) of the dielectric. The larger the permittivity the more efficient the capacitor is. The first capacitors used a vacuum as a dielectric which only had a permittivity of 1, now capacitors are made of materials such as barium titanate which have a permittivity of 30,000 (KEMET).

Zener Diode: “a semiconductor diode across which the reverse voltage remains almost constant over a wide range of currents, used especially to regulate voltage” (dictionary.com). Simply stated, it is a semiconductor that allows current to only flow in one direction opposed two. This is valuable in this invention because one diode prevents the battery from attempting to run the “electric dynamo back” which would result in no net energy being stored. Additionally the second zener diode will prove valuable due to reciprocating nature of the electric dynamo. When a person walks the leg moves back and forth (i.e. reciprocates). This causes the supercapacitor to be unable to charge

### The Invention

As stated earlier, the present invention relates to converting human movement into electricity. More particularly, the present invention relates to the conversion of body movement (e.g. leg, arm, shoulder, wrist, finger) into electricity energy which can then be stored in an electrical storage device (e.g. a battery or supercapacitor), or directly used to power electrical devices (e.g. cell phone battery, watch, portable media player (MP3)) This present invention operates in a portable fashion, so individuals could wear the present invention throughout daily activity (e.g. walking, running, climbing stairs).

### First Embodiment

By way of example, the present invention may be used to convert the kinetic energy from leg movement, such as walking, running, climbing, hiking, swimming, scuba diving, and snorkeling, into electrical energy that can be stored in a electrical storage device such as, a rechargeable battery, supercapacitor, or an external battery source such as a cell phone battery, watch, portable media player (MP3). The kinetic energy used to charge the electrical storage device is from the axial rotation of an electric dynamo such as at the consistent bending of the human fibula and tibia with the human femur at the knee joint when walking, jogging or running.

### Purpose:

The purpose of the field experiment is to test the present invention with human participants on a larger scale to find any flaws in the design and to further prove the present invention works.

### Materials:

1/10″ Uninsulated Copper Wire (2-3 ft.)
50 Farad 2.5V Kamcap Electrolytic Super Capacitor (1)
Electrical Tape (1 ft.)
15-Range Digital Multimeter (1)
Velcro™ Straps (Preferably with buckles)(3)
1N4004 Zener Diodes (2)
12 VDC 200 mA Hand Crank Dynamo (1)
Wooden Painter's Stick (1)
1″×¾″×14″ Aluminum Rod (1)
Stopwatch (1)
400 meter outdoor track
Gorilla™ Tape (1-2 ft.)
Gorilla™ Glue (2 fl. Oz)

### Methods:

1) Construct the present invention based on FIG. 2
2) Using the three Velcro™ Straps, mount the present invention to the right leg (for consistency) of the human participant as shown in the
3) Turn on the multimeter and turn it to setting “2V” or “20V” if charge exceeds 2 Volts
4) Measure and record the initial voltage of the supercapacitor by placing the positive and negative nodes of the multimeter to the corresponding positive and negative terminals of the supercapacitor
5) Instruct human participant to walk at a regular pace along the marked 100 meter path (Note: For most accurate results, have the participant walk along the straight portion of the track in the same lane), while he/she counts his/her strides (the number of times the leg with the present invention is moved)
6) Instruct either the proctor or another human participant count the participant instructed to walk's strides as well to confirm strides were correctly counted (Note: Do not use a pedometer since it is less accurate).
7) While the participant is walking have the proctor time the participant's 100 meter walk using the stopwatch
8) At the end of the 100 meter walk stop the stopwatch and record the time of the walk
9) Ask both the participant instructed to walk and the proctor/other participant counting the strides the number of strides they counted. If they agree upon the same number of strides record the data, if they counted a different number of strides repeat the experiment and have them count the number of strides together aloud.
10) Remove the present invention from the participant's leg by unstrapping the three Velcro Straps
11) Measure and record the final voltage of the supercapacitor as previously done in step 4

### Data:

### Quantitative Data: Refer to FIG. 3

### Qualitative Data:

Participants complained about the uncomfortable nature of the present invention
The cumbersome nature of the present invention caused some participants to walked with a more hindered gait than usual (limped)

### Analysis:

The present invention produced voltage for every trial in Field Study A; however, there was large variation in voltage output. For this reason the data must be analyzed to determine what factor is contributing to such a variance in voltage output.
Possible Factors Contributing to variation in voltage output
   Number of strides
   Speed (m/s)
   Participant Height (Affects length and number of strides)
   Participant Weight (Affects force exerted on present invention)
   Length of Stride
   Angular Velocity (angle and speed of movement

See FIG. 6 for Graph indicating Number of Strides vs. Voltage Output
It was originally perceived that the number of strides taken would be a major factor in voltage output, since the greater the number of strides the greater the opportunities to produce voltage; however, according to the graph, the line of regression (R-Squared) only explains 5.8% of the data. This means that the number of strides is not a major factor causing difference in voltage output.

See FIG. 7 for Graph indicating Stride Speed (m/s) vs. Voltage Output
It was originally perceived that stride speed was one of the major factors that affected voltage output; however, according to the r-squared it only explains 76% of the data. This means that there must be another factor that has not been identified that is affecting the voltage output even more than stride speed. Further research must be taken to find this factor.

See FIG. 8 for Graph indicating Stride Length (m) vs. Voltage
It was originally perceived that stride length would be a major factor in voltage output because it affects the distance the generator axle turns (the greater the distance the axle turns, the greater the voltage output. However, according to the graph, the line of regression (R-Squared) only explains 5.3% of the data. This means that it is not a major factor contributing to differences in voltage output.
It was noted that during the experiment that participants walked with different gaits as a result of the present invention. Some walked with a regular gait while others walked with a hindered one.

See FIG. 9 for Graph indicating Angular Velocity (rad/sec) vs Voltage Data and Line Fit Plot
It was perceived that angular velocity, or the speed of angular movement, was a factor contributing to variation in voltage output because it was noted during the experiment that the cumbersome nature of the present invention caused participants to walk with different gaits. For example, one participant would walk with a hindered gait/limping while another would walk with a regular gait.

Walking gait directly affects angular momentum because a participant with a hindered gait/limping walks with a shorter angle of movement and speed of movement (i.e. angular momentum) than the participant walking with a regular gait (longer and faster angle of movement). The prediction that angular momentum was the factor causing the variation in voltage is proven correct since the line of best fit (R-Squared) fits 97.7% of data.

Conclusion from Field Study: The present invention successfully produced voltage for every participant in the study; however, there was large variation in voltage output. It was originally thought that number of strides, walking speed, participant height, participant weight, angular velocity, and length of stride were factors that caused the difference in voltage output; however, after analysis only speed and angular velocity showed relation to the variation. Angular velocity could explain 97.7% of the variation in data and walking speed explained 76% of data.

### Example of Additional Field Study:

The purpose of this experiment is to prove that the assumption made in Field Study A is true—differences in walking gait/angular velocity cause variation in voltage output.

### Materials:

Present Invention
Multimeter
Marked 90 ft walking path
Notepad
Writing Instrument
Video Camera
Stop Watch
Human participants

### Methods:

1. Gather materials including human participants
2. Using the three Velcro Straps, mount the Eco-Motion to the right leg (for consistency) of the human participant as shown in the diagram below (Note: Mount according to the diagram below for the most consistent data)
3. Turn on the multimeter and turn it to setting “2V” or “20V” if charge exceeds 2 Volts
4. Measure and record the initial voltage of the supercapacitor by placing the positive and negative nodes of the multimeter to the corresponding positive and negative terminals of the supercapacitor
5. Turn on the video recording device
6. Instruct the human participant to walk along the marked 90 feet path at a regular walking pace, and at the same time record the leg movement to the participant walking
7. Upon the completion of the human participant's 90 feet walk, stop the video recording
8. Turn on the multimeter and turn it to setting “2V” or “20V” if charge exceeds 2 Volts
9. Measure and record the final voltage of the supercapacitor by placing the positive and negative nodes of the multimeter to the corresponding positive and negative terminals of the supercapacitor
10. Repeat steps 3-9 except have the human participant walk with a weaker gait (with a less bent knee/stiffened leg)
11. Repeat steps 3-9 except have the human participant walk with a stronger gait than a regular walk (with a higher bent knee)
12. Upload the recorded videos of the participant walking onto a computer
13. Using video editing software, screenshot pictures were the knee is bent for each of the three types of walks (see diagram below for example)
14. Print the three screenshots of the knees being bent
15. Using a protractor find the angle the knee was bent as shown in the example below:
16. Calculate Angular Velocity and examine data

Data:

See FIG. 4 for Data Table Relating Angular Velocity and Voltage Output

See FIG. 5 for Diagram indicating how Angular Velocity was Calculated

### Analysis:

See FIG. 9: for Graph indicating Angular Velocity (rad/sec) vs Voltage Data and Line Fit Plot

Data analysis showed that angular velocity had a significant impact on voltage output as its R-square was 0.97 or in other words angular velocity can explain differences in voltage output for 97% of the data. This proves the notion made in Field Study A: angular velocity caused the variation in voltage output.

The results of this field experiment showed that angular velocity has a significant correlation (97%) with variation in voltage output. This proved the notion made in Field Study A: angular velocity caused the variation in voltage output. Based on the data it can be predicted that the activities a person does while wearing the present invention (running, walking, etc.) will have a major impact on voltage output. There was limitation in the fact that there was human error in calculating the speed vector for angular velocity, as it was a below 1 second value calculated by with a stopwatch.

### Second Embodiment

By way of example, the present invention may be used to convert the kinetic energy from arm movement, such as walking, running, climbing, hiking, swimming, scuba diving, and snorkeling, into electrical energy that can be stored in a electrical storage device such as, a rechargeable battery, supercapacitor, or an external battery source such as a cell phone battery, watch, portable media player (MP3). The kinetic energy used to charge the electrical storage device is from the axial rotation of an electric dynamo such as at the consistent bending of the human radius and ulna with the human humerus at the elbow joint when walking, jogging or running.

### Third Embodiment

By way of example, the present invention may be used to convert the kinetic energy from shoulder movement, such as walking, running, climbing, hiking, swimming, scuba diving, and snorkeling, into electrical energy that can be stored in a electrical storage device such as, a rechargeable battery, supercapacitor, or an external battery source such as a cell phone battery, watch, portable media player (MP3). The kinetic energy used to charge the electrical storage device is from the axial rotation of an electric dynamo such as at the consistent bending of the human humerus with the human scapula at the shoulder joint when walking, jogging or running.

### Fourth Embodiment

By way of example, the present invention may be used to convert the kinetic energy from finger and wrist movement, such as writing, typing, into electrical energy that can be stored in a electrical storage device such as, a rechargeable battery, supercapacitor, or an external battery source such as a cell phone battery, watch, portable media player (MP3). The kinetic energy used to charge the electrical storage device is from the axial rotation of an electric dynamo such as at the consistent bending of the fingers and wrist at the various wrist and finger joints when walking, jogging or running.

### Fifth Embodiment

By way of example, the present invention may be used to convert the kinetic energy from ankle and foot wrist movement, such as walking, running, and climbing stars into electrical energy that can be stored in a electrical storage device such as, a rechargeable battery, supercapacitor, or an external battery source such as a cell phone battery, watch, portable media player (MP3). The kinetic energy used to charge the electrical storage device is from the axial rotation of an electric dynamo such as at the consistent bending of the foot and ankle at the various ankle and foot joints when walking, jogging or running.

### REFERENCES

### Works Cited

Bassett, David R., Jr., Holly R. Wyatt, Helen Thompson, John C. Peters, and James O. Hill.

“Pedometer-measured Physical Activity and Health Behaviors in U.S. Adults.” Medicine & Science in Sports & Exercise 42.10 (2010): 1819-825. Print.
Battery University. “Supercapacitor.” Information—Battery University. N.p., n.d. Web. 6 Oct. 2013.
Beauvais, Kristy, and Steven Leeb. “The Simple DC Motor: A Teacher's Guide.” MIT.edu. Massachusetts Institute of Technology, 2003. Web. 9 Nov. 2013.
Brain, Marshall, Charles W. Bryant, and Clint Pumphrey. “How Batteries Work.” How Batteries Work. How Stuff Works.com, n.d. Web. 10 Nov. 2013.
Brain, Marshall, William Harris, and Robert Lamb. “How Electricity Works.” How Electricity Works. HowStuffWorks, n.d. Web. 13 Nov. 2013.
Britannica.com. “Faraday's Law of Induction (physics).” Encyclopedia Britannica Online. Encyclopedia Britannica, n.d. Web. 9 Nov. 2013.
Dictionary.com. “Dynamo Electric.” Dictionary.com. Dictionary.com, n.d. Web. 13 Apr. 2014.
Dictionary.com. “Zener Diode.” Dictionary.com. Dictionary.com, n.d. Web. 13 Apr. 2014.
Georgia State Univeristy. “Conductors and Insulators.” Conductors and Insulators. Georgia State Univeristy, n.d. Web. 10 Nov. 2013.
Gogotsi, Yury. “Nanoscale Advances Lead to Big Power for Supercapacitors: Capacitors' Energy Density Is Climbing towards That of Batteries by Using Nanostructured Electrodes and New Electrolytes.” Machine Design 11 Aug. 2011: 54. Student Resources in Context. Web. 13 Nov. 2013.
<http://go.galegroup.com/ps/i.do?id=GALE %7CA297716151&v=2.1&u=alpharetta&it=r &p=GPS&sw=w&asid=9553f649279ace8eb801cf137b021228>.
KEMET Electronics Corporation. “What Is a Capacitor?” KEMET Electronics Corporation, Jan. 1996. Web. 6 Oct. 2013.
Windell. “Evil Mad Scientist Laboratories.” Basics: Introduction to Zener Diodes. Evil Mad Scientist Laboratories, 12 Jan. 2012. Web. 12 Nov. 2013.

### BRIEF DESCRIPTION OF THE SEVERAL VIEWS OF THE DRAWINGS

FIG. 1: Detailed Schematics of the Present Invention (without circuit)

FIG. 2: Detailed Schematics of the Circuit from the Present Invention (with circuit)

FIG. 3: Data Table Indicating the Results of the Experimentation Described in the Methods

FIG. 4: Data Table Relating Angular Velocity and Voltage Output

FIG. 5: Diagram indicating how Angular Velocity was Calculated

FIG. 6: Graph indicating Number of Strides vs. Voltage Output

FIG. 7: Graph indicating Stride Speed (m/s) vs. Voltage Output

FIG. 8: Graph indicating Stride Length (m) vs. Voltage Output (V)

FIG. 9: Graph indicating Angular Velocity (rad/sec) vs Voltage Data and Line Fit Plot

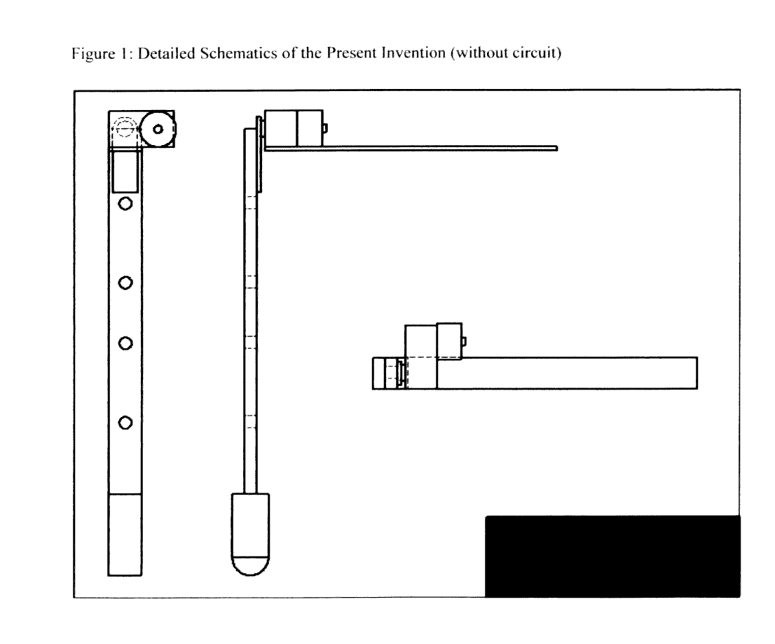

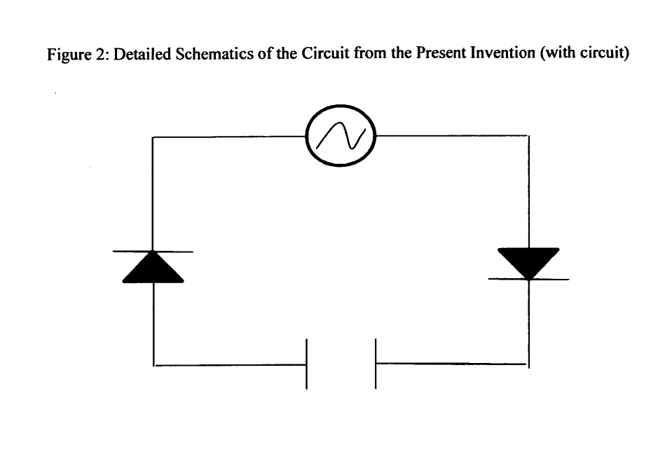

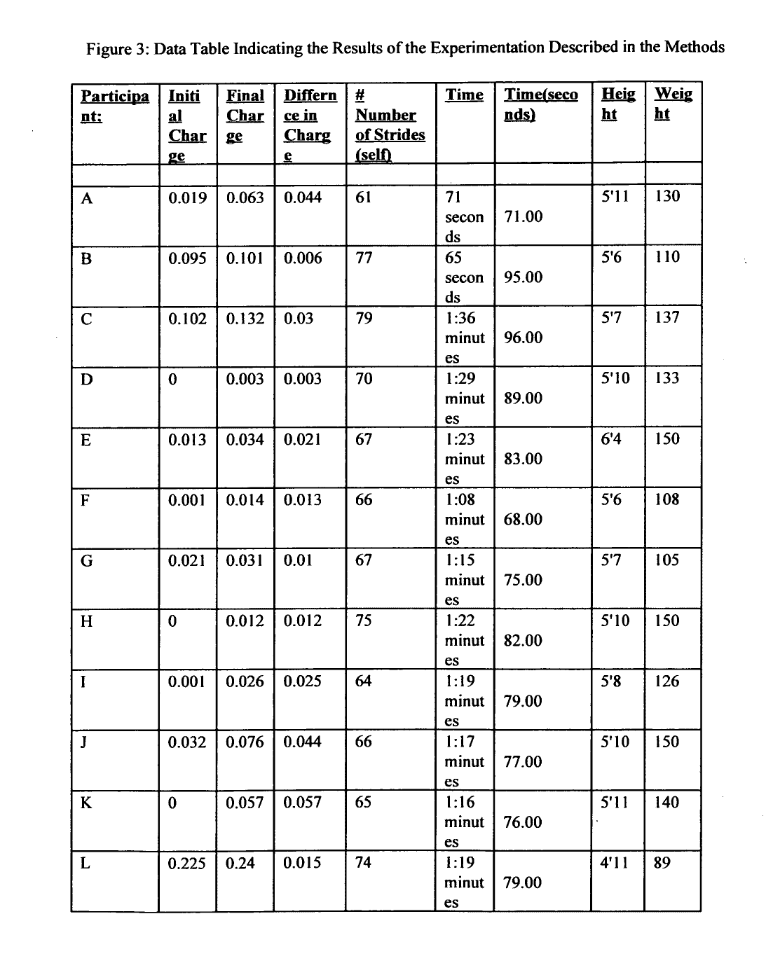

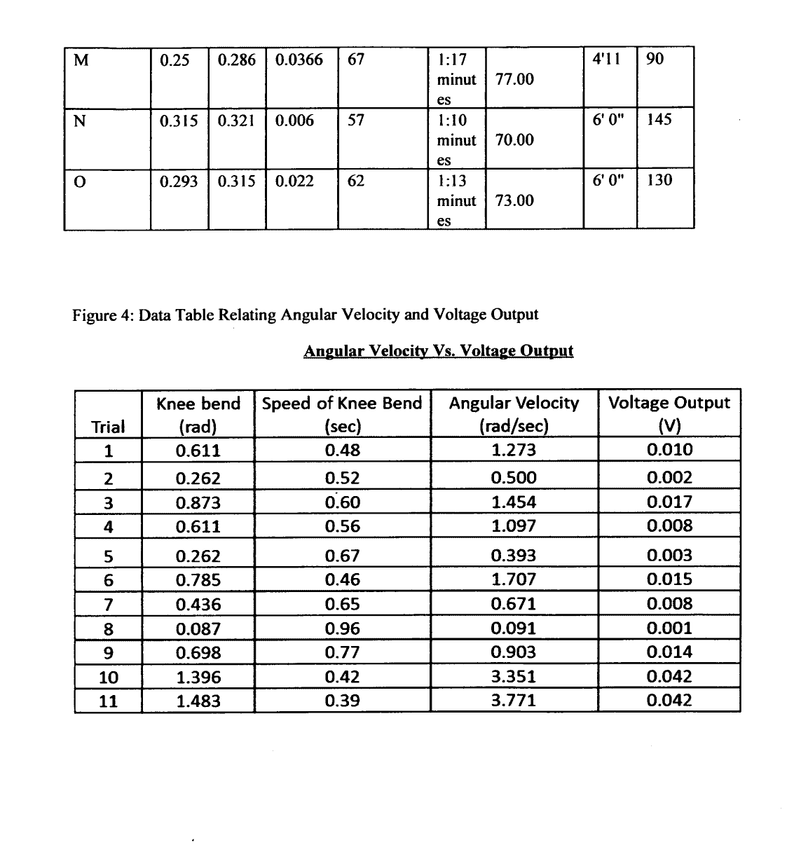

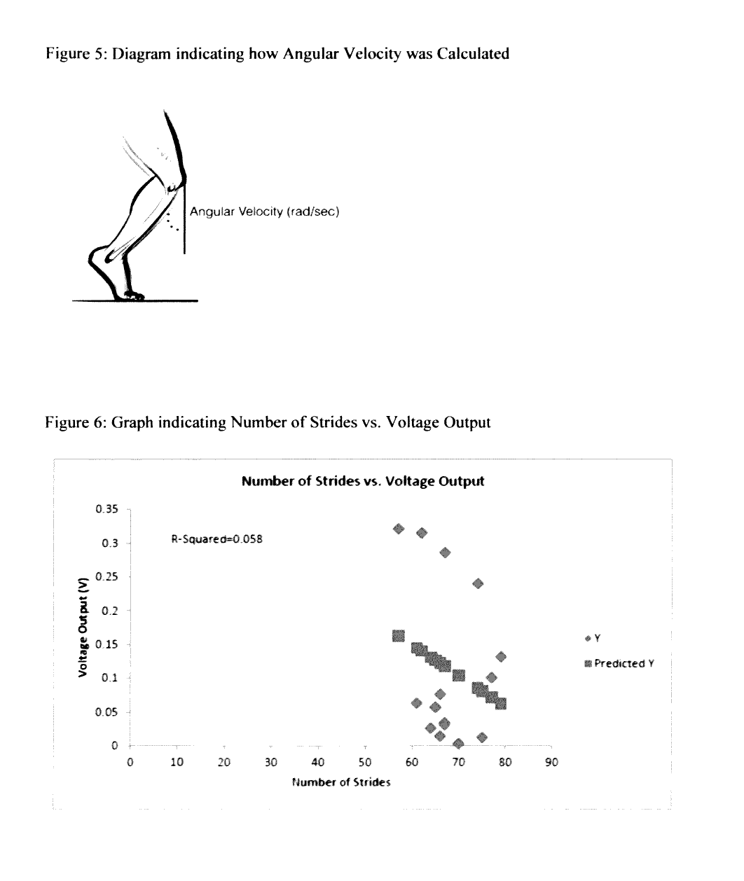

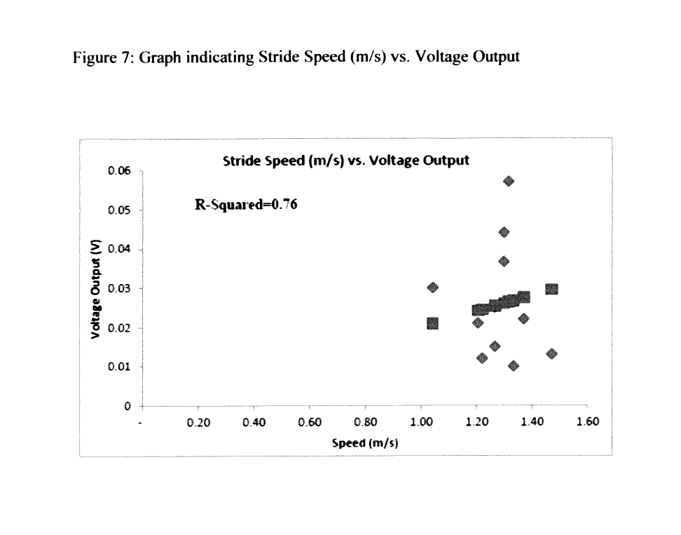

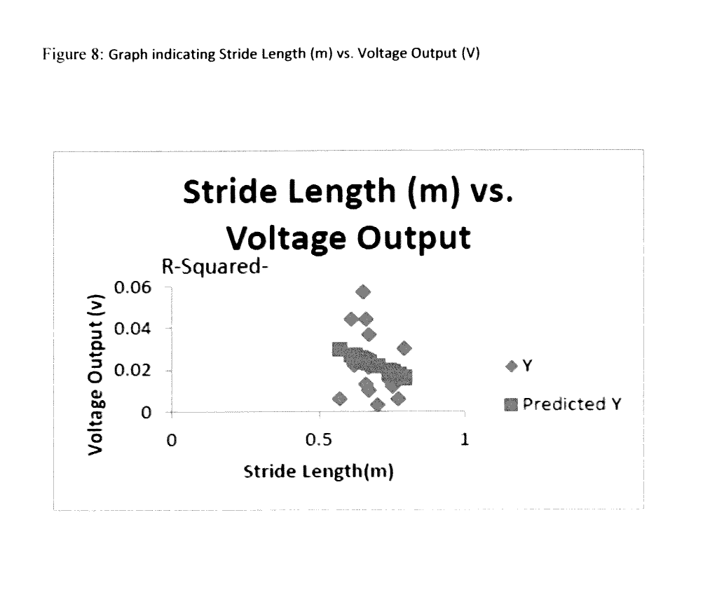

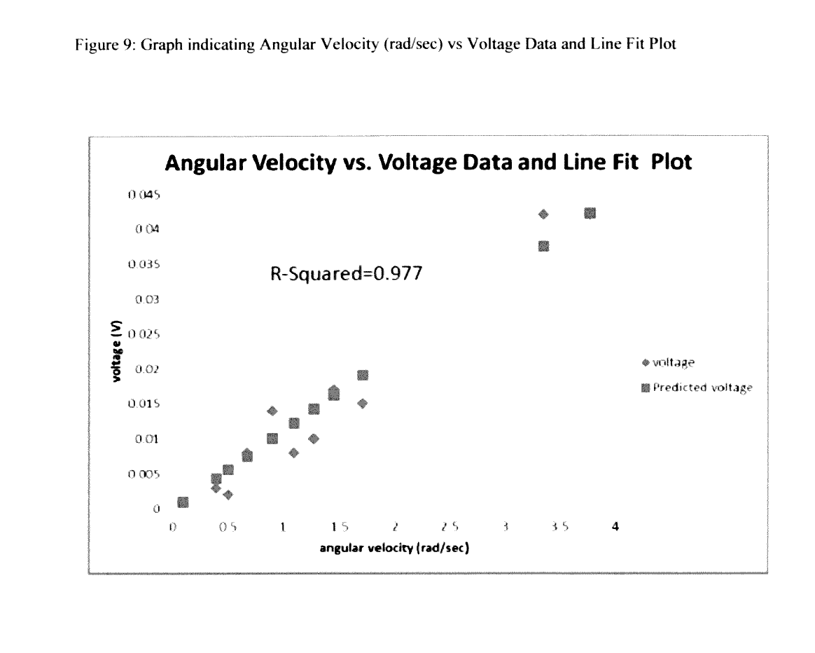

1. A device that converts the kinetic energy from body movement at joints into electrical energy using an electric dynamo and stores it in an electrical storage device. The placement of the electric dynamo is in such a fashion that it models the axial rotation and movement at a joint. Specifically when the joint bends/moves so does the electric dynamo arm which generates electrical energy
A device claimed in 1 using leg movement at the knee joint into electrical energy using an electric dynamo and stores it in an electrical storage device
A device claimed in 1 using shoulder movement at the shoulder joint into electrical energy using an electric dynamo and stores it in an electrical storage device
A device claimed in 1 using arm movement at the elbow joint into electrical energy using an electric dynamo and stores it in an electrical storage device
A device claimed in 1 using finger movement at the finger joints into electrical energy using an electric dynamo and stores it in an electrical storage device
A device claimed in 1 using wrist movement at the wrist joint into electrical energy using an electric dynamo and stores it in an electrical storage device
A device claimed in 1 using foot and ankle movement at the ankle joint into electrical energy using an electric dynamo and stores it in an electrical storage device

2. The energy produced in the present invention can be stored in an electrical storage device, including but not limiting to a rechargeable battery and/or supercapacitor,

3. The energy produced from the present invention can be used to power or charge an external device, including but not limiting to cell phones, MP3 players, watches, and/or portable media
